(19) United States
(12) Patent Application Publication
(10) Pub. No.: US 2020/0248500 A1
(43) Pub. Date: Aug. 6, 2020

(54) Adjustable Door Sweep

(71) Applicant: James O'Shea, Wildwood, MO (US)

(72) Inventor: James O'Shea, Wildwood, MO (US)

(21) Appl. No.: 16/263,533

(22) Filed: Jan. 31, 2019

(51) Int. Cl. E06B 7/23

(52) U.S. Cl. CPC E06B 7/2316

(57) ABSTRACT

The present invention is an adjustable door sweep that would be available as either 1.) an accessory attached to the bottom of an exterior door or 2.) an integrated component of a newly manufactured exterior door. Both embodiments would feature a ½″ thick, loose bundle of 2.5″ long nylon sweep bristles running the width of the door and protruding from a ½′″ aperture on the bottom of the door or accessory. When deployed from the bottom of the door or accessory, they would conform perfectly to the exact surface of the threshold.

### FIELD OF THE INVENTION

The present invention (both embodiments) generally relates to door sweeps and seals, and more specifically relates to door sweeps that are adjustable.

### BACKGROUND OF THE INVENTION

The installation of a hinged exterior door often results in gaps between the threshold (whether manufactured or a natural ground surface) and the bottom of the door. To prevent, or at least mitigate, the migration of insects, snakes, rodents, dust, leaves, etc. from entering via those gaps, devices such as weather stripping, seals, and traditional door sweeps have been utilized. However, such devices are typically either a.) a predetermined, non-adjustable height and therefore may not close the gap or b.) have an adjustable height but is unable to follow the slope and/or contour of the threshold surface.

### SUMMARY OF INVENTION

The present invention is an adjustable door sweep capable of conforming to the exact slope and contour of the threshold surface, whether natural or man-made. It can be provided as an add-on accessory to an existing door or be integrated into a newly manufactured door. These and other features, aspects and advantages of the present invention will become better understood with reference to the following drawings, description and claims.

### BRIEF DESCRIPTION OF THE DRAWINGS

FIG. 1 is an elevational angled front view of an existing exterior door embodying the present invention as an add-on accessory.

FIG. 2 is an elevational angled front view of a newly manufactured door embodying the present invention as an integrated component of said door.

FIG. 3 is an elevational side view of the present invention as an integrated component of a door and with sweep bristles not deployed.

FIG. 4 is an elevational side view of the present invention as an integrated component of a door and with sweep bristles deployed over an uneven threshold surface.

FIG. 5 is an elevational side view of the present invention as an add-on accessory attached to an existing exterior door (displayed), and with sweep bristles deployed over an uneven threshold surface.

FIG. 6 is a cross-sectional front view of the present invention (both integrated and accessory embodiments), showing the pressure plate flanges engaged with the plate carrier channels.

### DETAILED DESCRIPTION

The first embodiment of the present invention (claim 1) is an adjustable door sweep designed to be attached to the bottom of an exterior door as an accessory. Said adjustable door sweep is housed in a hollow aluminum frame 1″ thick and 3″ tall, has a ½″ wide aperture in the bottom running its entire length, and is available in lengths corresponding with all popular door sizes such as 24″, 28″, 30″, 32″, 36″, etc. The hollow aluminum frame comprises a.) a horizontal plate spanning the thickness of the frame mounted ½″ from its top, running its entire length, and featuring multiple grooves (plate carrier channels) b.) a 2.25″ tall aluminum pressure plate also running the entire length of the frame, coated in rubber, and including Y-shaped appendages (plate carrier flange) on the top that would ride inside the plate carrier channels, c.) an approximate ½″ thick bundle of loose, 2.5″ long nylon sweep bristles embedded inside the frame vertically and spanning the entire length of the frame, d.) eight or ten set screws (depending on the width of the specific door it is attached to) used to release or push the pressure plate into position thereby locking the nylon sweep bristles in place, f.) four or five retraction springs (depending on the width of the door) used pull the pressure plate back once the set screws are loosened so that the sweep bristles are free to deploy, g.) a decorative cover matching the most popular door colors such as white, black, bronze, etc. with eight or ten (depending on the width of the door) threaded holes and screw channels for the set screws to travel and, h.) plastic hole plugs designed to conceal the screw heads and color coordinated to match the cover. The first embodiment of the present invention includes a method of using an adjustable door sweep such as that just described. The method includes attaching the adjustable door sweep onto the bottom of a door with ten to twelve machine screws (depending on width of door) that fasten the inside vertical surface of the aluminum frame to the door. Once the adjustable door sweep is attached and the door is in the closed position, the pressure plate is loosened by backing out the set screws in the frame which enables the retraction springs to pull the pressure plate backward. With no pressure holding them in place, the nylon sweep bristles are able to drop out the aperture at the bottom of the frame. These sweep bristles will each drop as far as they can but will vary in travel depending on the contour of the surface below. Once the bristles are all in contact with the threshold surface, the pressure plate is retightened locking the bristles in place and providing a sweep perfectly conformed to the threshold. The color coordinated screw hole caps are then attached covering the set screw holes in the cover.

The second embodiment of the present invention (claim 2) is an adjustable door sweep designed to be integrated into the interior of a newly manufactured door. The door itself would include a hollow compartment its entire thickness and would be approximately 3″ high with ½″ aperture across its bottom horizontal surface. The door would feature eight or ten holes and threaded screw sleeves (depending on door width) spanning the bottom of its vertical surface. Said embodiment is comprised of the same components and functionality of the first embodiment and includes a.) a horizontal plate spanning the thickness of the door mounted 2.5″ from its bottom and running its entire width, and featuring multiple grooves (plate carrier channels) b.) a 2.25″ tall aluminum pressure plate also running the width of the door, coated in rubber, and including a Y-shaped appendage (plate carrier flange) on the top that would ride inside the plate carrier channels, c.) an approximate ½″ thick bundle of loose, 2.5″ long nylon sweep bristles embedded inside the door vertically and spanning its entire width, d.) eight or ten set screws (depending on the width of the specific door) used to release or push the pressure plate into position thereby locking the nylon sweep bristles in place, f.) four or five retraction springs (also depending on the width of the door) used to pull the pressure plate back once the set screws are loosened so that the sweep bristles are free to deploy, and g.) plastic hole plugs designed to conceal the screw heads and color coordinated to match the door.

The second embodiment of the invention includes a method of using an adjustable door sweep such as that described. The method includes deploying the sweep bristles through an aperture on the door bottom to adhere to the threshold surface when the door is closed. The set screws holding the pressure plate in place are backed off, allowing the nylon sweep bristles to fall out the aperture at the bottom of the door. These nylon bristles will each drop down as far as they can but will vary in travel depending on the contour of the surface below. Once the bristles are all in contact with the threshold surface, the pressure plate is retightened locking the bristles in place and thereby forming a door sweep that perfectly conforms to the threshold surface. The color coordinated screw hole caps are then attached covering the threaded holes.

Other objects and purposes of the invention, and variations thereof, will be apparent upon reading the following specification and inspecting the accompanying drawings.

### DETAILED DESCRIPTION OF DRAWINGS

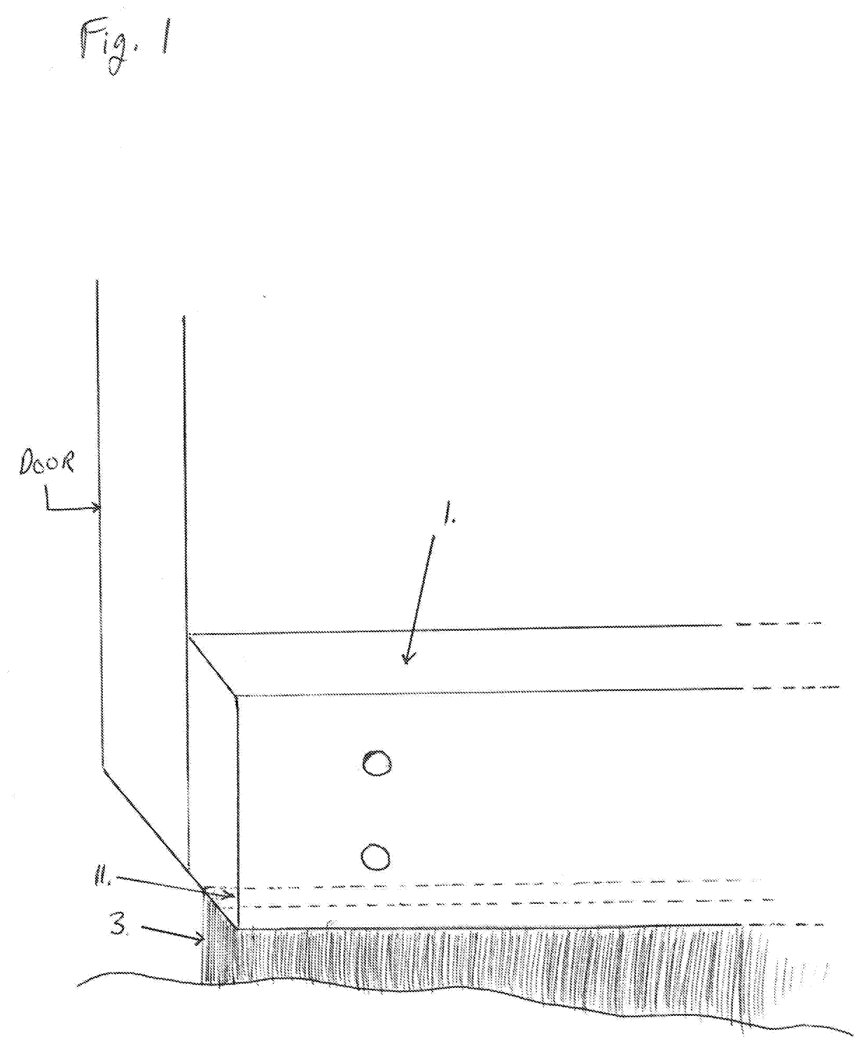

FIG. 1 shows an elevational angled front view of the bottom of an exterior screen door with the present invention attached as an accessory as described in claim 1. The adjustable door sweep's bristles (3) are shown protruding from the aperture (11) in the frame (1) and deployed over a threshold surface that is both uneven and slopes away from the hinged side of the door, as in the case in most patios and decks.

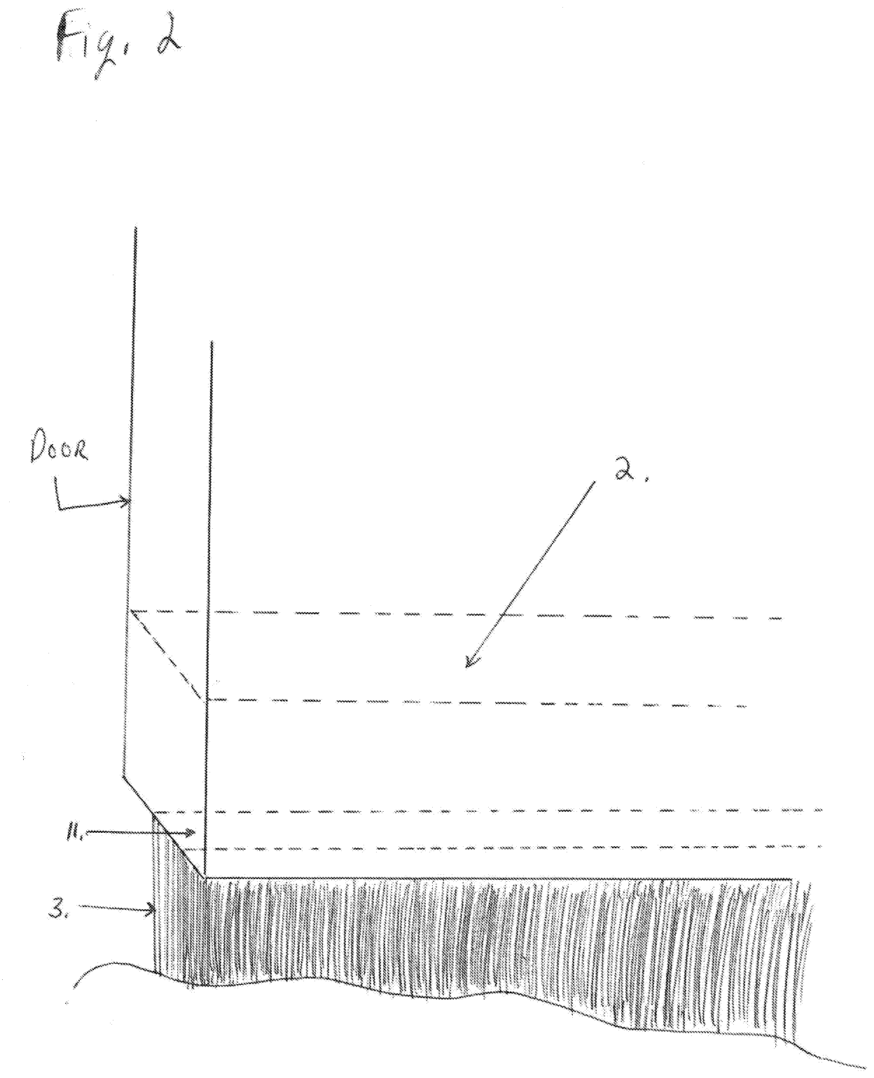

FIG. 2 shows an elevational angled front view of the bottom of an exterior door with the present invention installed inside a housing (2) within said door as an integrated component as described in claim 2. The adjustable door sweep's bristles (3) are shown protruding from the aperture (11) and deployed over a threshold surface that is both uneven and slopes away from the hinged side of the door as in the case in most patios and decks.

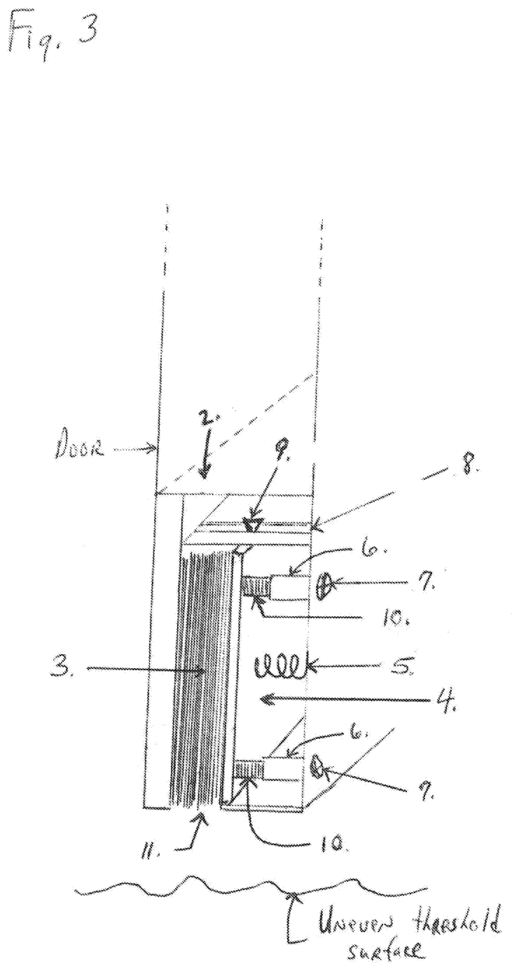

FIG. 3 shows an elevational side view of the present invention installed as an integrated component within a housing (2) inside a newly manufactured door as described in claim 1. The left side shows undeployed sweep bristles (3) inside the housing (2) and above an aperture (11) in the door bottom and held in place by the pressure plate (4). The right side shows the set screws (10) used to, in conjunction with the pressure plate (4), lock the nylon sweep bristles (3) in place once deployed over the threshold surface. The pressure plate flanges (9) and plate carrier channels (8) guide the pressure plate (4) back and forth, and the retraction spring (5) is used to pull the pressure plate (4) back to enable deployment of the bristles (3). Once set screws (10) are advanced inside the set screw sleeves (6) and tightened against the pressure plate (4), color-coordinated hole caps (7) are plugged into the set screw holes.

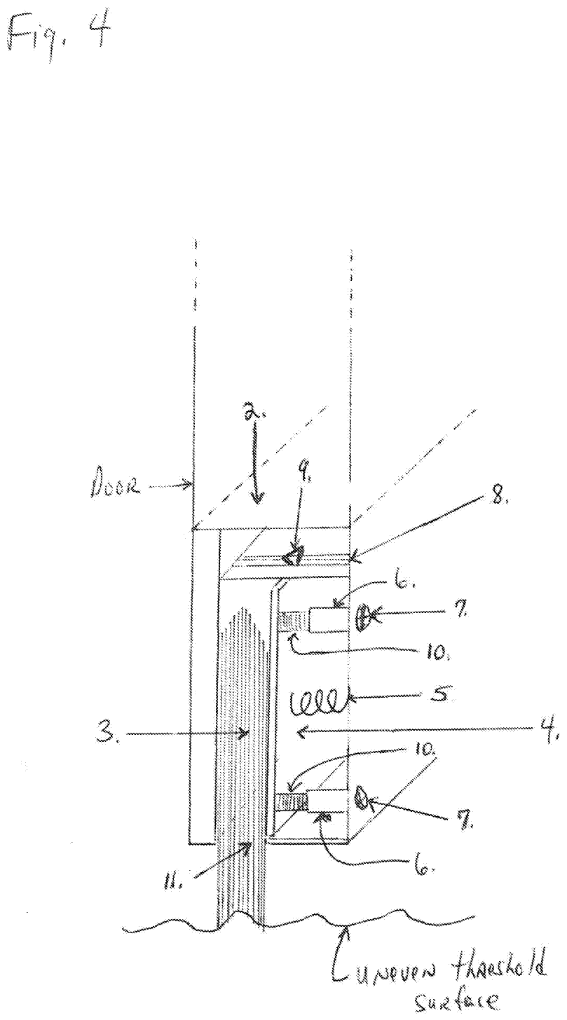

FIG. 4 is a version of FIG. 3 with the present invention's bristles (3) deployed over an uneven threshold surface.

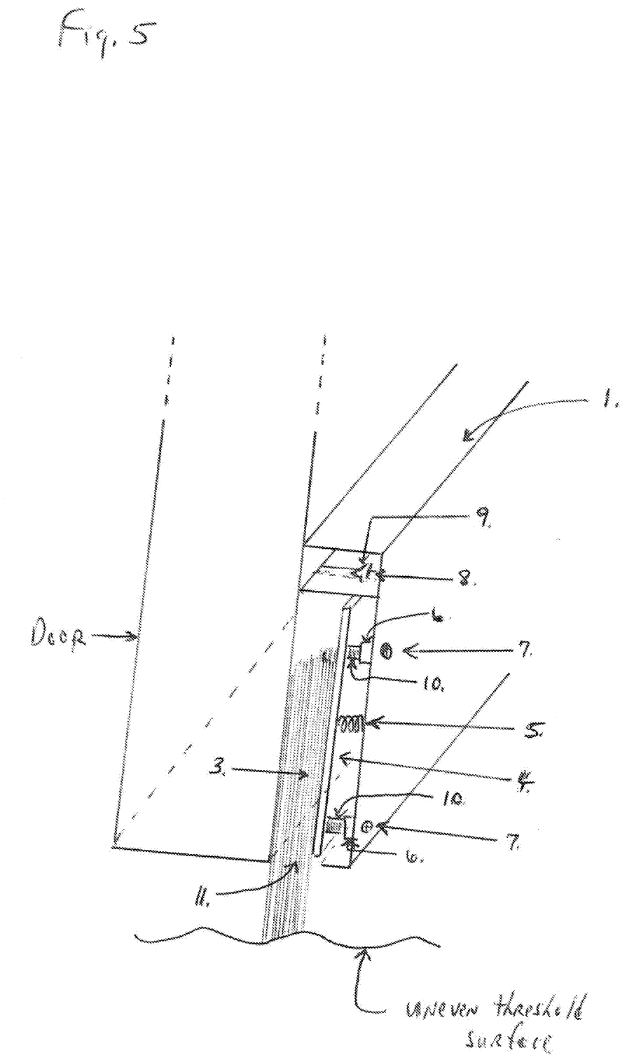

FIG. 5 shows is a side view of the present invention installed as an accessory to an existing exterior door as described in claim 1. The left side shows the bottom of an exterior door and the right side shows the present invention's frame (1) attached to said door. Sweep bristles (3) are shown deployed through the aperture (3) in the frame (1) bottom and held in place by the set screws (10) and pressure plate (4). The remaining components are consistent with FIG. 3 and FIG. 4.

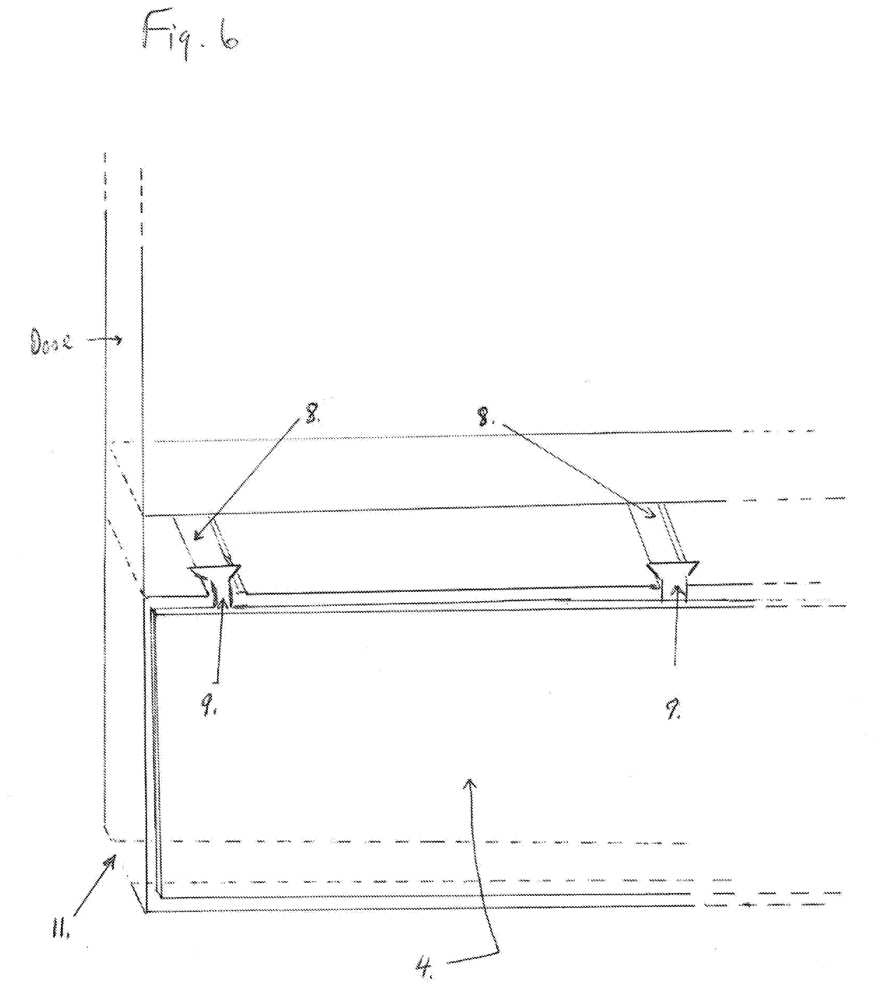

FIG. 6 shows the pressure plate's flanges (9) engaged in the plate carrier channels (8). The channels would enable the pressure plate (4) to move horizontally either backward to release pressure on the sweep bristles (3) and enabling deployment, or forward through the channels (8) to lock the deployed sweep bristles (3) in place.

### PRIOR ART

| | | | | Ad- |
|---|---|---|---|---|
| | | | | justable |
| | | | | to |
| | Adjustable | Self- | Adjustable | Uneven |
| | Vertically | Adjustable | to Slope | Surface |
| Present Invention | X | X | X | X |
| U.S. Pat. No. 8,381,448 | X | | | |
| U.S. Pat. No. 5,174,065 | X | | | |
| U.S. Pat. No. 5,056,263 | X | X | | |

### Advantages of Invention

The above-described present invention and method of using the present invention (both attached and integrated embodiments) provide advantages over other adjustable door sweeps available on the market. The present invention is easy to manufacture, install, and use. Moreover, the above-described adjustable door sweep (both embodiments) allows its vertically positioned nylon bristles to move independently of each other in order to exactly conform to virtually any threshold surface the door closes over, preventing or at least mitigating insects, small animals such as mice or snakes, or any dirt or plant material from entering via wind or other factors. The adjustable door sweep's ability to be provided as either an add-on door accessory or integral to a newly manufactured door is another clear advantage of present invention.

Although particular preferred embodiments of the invention have been disclosed in detail for illustrative purposes, it will be recognized that variations or modifications of the disclosed apparatus, including the rearrangement of parts and their applications, lie within the scope of the present invention.

I claim:

1. One embodiment of the present invention is an adjustable door sweep designed to be attached to an exterior door as an add-on accessory. This embodiment would consist of a hollow aluminum frame 1″ deep and 3″ tall with a ½″ wide aperture across the bottom of its entire length. The embodiment would attach to the bottom and run the entire width of an exterior door, and be available in all popular door sizes such as 30″, 32″, 36″, etc. Said hollow aluminum frame interior would include a horizontal plate ½″ from the top with narrow slots (plate carrier channels) across the depth of the frame to allow the pressure plate to travel. The embodiment would also include a.) an approximate ½″ thick bundle of loose, 2.5″ long nylon bristles embedded inside the frame vertically and running the entire horizontal length of the frame, b.) a 2.25″ high aluminum pressure plate running the entire horizontal length of the frame, coated in rubber, and including several Y-shaped appendages (plate carrier flanges) on the top that would seat inside the plate carrier channels, d.) three to five (depending on door width) retraction springs attached to the pressure plate and cover, and designed to retract the pressure plate from the sweep bristles (after set screws are backed off) to enable their deployment, e.) a decorative cover with eight to ten (depending on door size) pre-drilled holes and screw sleeves and powder-coated to match the most popular door colors such as white, black, bronze, etc. and f.) eight or ten (depending on door size) set screws and color coordinated plastic hole caps.

2. A second embodiment of the present invention would be an integrated version of above adjustable door sweep (claim 1) that would be incorporated into the hollow bottom of a new door by the door's manufacturer. This embodiment would consist of the same components as above except for the hollow aluminum frame whose place would be taken by the bottom of the door interior itself. Said door interior would include a horizontal plate 2½″ from the bottom of the door with narrow slots (plate carrier channels) across the thickness of the door to allow the pressure plate to travel. The embodiment would also include a.) an approximate ½″ thick bundle of loose, 2.5″ long nylon bristles embedded inside the door vertically and running the entire horizontal width of the door, b.) a 2.25″ high aluminum pressure plate running the entire width of the door, coated in rubber, and including several Y-shaped appendages (plate carrier flanges) on the top that would seat inside the plate carrier channels, d.) three to five (depending on door width) retraction springs attached to the pressure plate and cover, and designed to retract the pressure plate from the sweep bristles (after set screws are backed off) to enable their deployment, e.) eight or ten pre-drilled holes and screw sleeves (depending on door width) in the bottom of the door's vertical face and f.) eight or ten (depending on door width) set screws and color coordinated plastic hole caps.
